(19) United States
(12) Patent Application Publication
(10) Pub. No.: US 2003/0140129 A1
(43) Pub. Date: Jul. 24, 2003

(54) Installing communication protocol in a handheld device

(76) Inventors: Noam Livnat, Menlo Park, CA (US); Hon Tat Lau, Berkeley, CA (US)

Correspondence Address: FISH & RICHARDSON P.C., 500 ARGUELLO STREET, SUITE 500, REDWOOD CITY, CA, 94063, US

(21) Appl. No.: 10/058,494

(22) Filed: Jan. 24, 2002

(51) Int. Cl. G06F 15/177

(52) U.S. Cl. 709/221; 709/228

(57) ABSTRACT

Methods and system for delivering a communication protocol to a handheld electronic device. The techniques include physically attaching a first device having a first communication protocol to a second device having a plurality of communication protocols, the plurality including the first communication protocol and a second communication protocol, determining that the second communication protocol is not installed on the second device, based on this determination, selecting the first communication protocol from the plurality of communication protocols, and establishing communication between the first and second devices using the first communication protocol, transferring the second communication protocol from the second device to the first device, installing the second communication protocol on the first device, and switching to the second communication protocol for further communication. In one embodiment, the communication protocols are software-based and the electronic devices are hand-held devices such as PDAs, cell phones, and digital cameras.

### BACKGROUND

The present invention concerns the delivery and installation of communication protocols to electronic devices, particularly handheld devices that can accommodate hardware add-ons.

Handheld devices such as personal digital assistants (PDAs), digital cameras, or cellular phones generally contain microprocessors or application-specific integrated circuits (ASIC) with at least a limited capability of running software or microcode. Over time, the device manufacturers or third party vendors may provide these handheld devices with new types of hardware such as CompactFlash-compatible cards or other add-on modules which can be inserted into an “expansion slot” or “socket” on the handheld device to provide expanded functionality.

Typically, the device manufacturer, third party hardware vendor, or third party software vendor periodically provides software upgrades such as bug fixes or functions that support or rely on recently introduced hardware add-ons.

Conventionally, the software upgrade necessary for the handheld device to interact properly with the add-on module is not provided as part of the hardware add-on. It is up to the user to locate and obtain the upgrade from another location, such as from the Internet or from a compact-disc (CD) sold with the provider device. Devices without network access would first need to be connected to a network-enabled device or CD drive, respectively.

Many times users avoid performing the upgrade due to their lack of technical expertise or the worry that an upgrade gone awry can damage their product and render it useless. That being the case, the need to perform the upgrade many times prevents the user from acquiring the new hardware in the first place. Thus, there is a need for a method that simplifies the upgrade process for users of handheld devices.

### SUMMARY

In general, in one aspect, the invention provides methods and system for delivering a communication protocol to a handheld electronic device. The techniques include physically attaching a first electronic device having a first communication protocol to a second device having a plurality of communication protocols, the plurality of communication protocols including the first communication protocol and a second communication protocol, establishing communication between the first and second devices using the first communication protocol, transferring the second communication protocol from the second device to the first device, installing the second communication protocol on the first device, and switching to the second communication protocol for further communication. The techniques further include transferring the second communication protocol from the second device to the first device, installing the second communication protocol on the first device, and switching to the second communication protocol for further communication.

Particular embodiments can include one or more of the following features: The first and second communication protocol can be software communication protocols. The first and second devices can be handheld electronic devices. The established communication can be point-to-point communication.

The invention can be implemented to realize one or more of the following advantages. Communication can be established between two devices which initially are incapable of communicating in the way that would allow for optimal or intended operation. The establishment of communication can occur in conjunction with delivering and installing a new communication protocol on the recipient device, the new communication protocol providing the recipient device with enhanced functionality. The delivery and installation of the new communication protocol, including the establishment of communication, can occur with minimal user involvement. User involvement can be limited to physically attaching the two devices together. The present invention is particularly advantageous for devices with limited user-configurability or limited input/communication paths.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A illustrates a provider device.

FIG. 1B illustrates a hardware add-on for a PDA.

FIG. 2A illustrates a recipient device.

FIG. 2B illustrates a microprocessor-based handheld electronic device.

FIG. 3 illustrates the information flow between the provider and the recipient.

### DETAILED DESCRIPTION

Before a software application can be delivered to a recipient electronic device, communication must be established with that device. A potential problem is that the device delivering the application (“the provider device”) may not be able to communicate with the recipient because the recipient uses a different communication protocol.

A communication protocol is an agreed-upon set of rules for transmitting data between two endpoint devices. The communication protocol is distinct from the transmitted data itself which can be raw data (eg. sound, images) or an executable program such as a software application or upgrade. An increasingly common feature of software applications is that they are self-installing. However, even if the application were self-installing, the application could not be delivered to a recipient device until communication between the recipient and the provider device has been established via a shared communication protocol.

The present invention deals with the situation where the provider device and the recipient device initially use different communication protocols and therefore initially do not share the communication protocol or protocols that would allow for them to communicate in an optimal or intended way. This situation can occur, for example, if the communication protocol used by recipient device has been out-dated by a newer, more advanced communication protocol. The present invention provides a system and method for the provider device to establish communication with the recipient device, thereby allowing the provider to install a different communication protocol on the recipient. Installing the different communication protocol on the recipient may provide the recipient with enhanced functionality which it previously was incapable of accessing via the previous communication protocol.

In one embodiment, the provider device is capable of using a plurality of communication protocols stored within the provider device, including the communication protocol initially used by the recipient device and the new communication protocol to be delivered to the recipient device. The provider device can be configured to determine which communication protocol currently exists on the recipient device. Based on this determination, the provider can select a corresponding communication protocol from the plurality of stored communication protocols and use the corresponding communication protocol to establish communication with the recipient device. Once communication has been established, a different communication protocol can be transferred to and installed on the recipient.

The transferred communication protocol can be a hardware-based protocol, a software-based protocol or a hardware and software-based protocol. A hardware-based protocol specifies rules concerning hardware aspects of the devices which are user-configurable (eg. changing the clock speed or timing diagram of the device). Hardware-based protocols can be implemented as firmware. Software-based protocols do not specify hardware attributes. Instead, software protocols specify, in terms of bits and bytes of data, how to arrange and parse the data (eg. which bits comprise the header of the message versus the content of the message).

In one embodiment, the delivery of the new communication protocol occurs via a point-to-point connection between the recipient and the provider as opposed to via a network connection. In a point-to-point connection, the data is transmitted from the provider directly to the recipient without any intermediate devices or infrastructure to route or relay the data. Amplification of the data may also not be necessarily, for example, if the two devices are physically attached or in close proximity of one another. Point-to-point communication protocols typically call for sending a direction bit which indicates which device is the sender and which is the recipient.

The present invention is particularly advantageous for devices with limited input capabilities. Specifically, devices which:

(a) lack convenient network access at a bandwidth appropriate for delivering the new protocol—e.g., downloading the protocol would take too long;

(b) lack convenient upgrade paths—e.g., disk drives; or

(c) are not very user-interactive or user-configurable—for example, PDAs and cell phones are much less user-configurable than a PC and a consumer electronic device like a digital camera or camcorder is even less interactive.

In one embodiment, the recipient is a handheld device that supports hardware add-ons. Exemplary mobile devices include PDAs (such as the Palm M505 by Palm, the Visor by Handspring, or the iPaq by Compaq Computer) and cellular phones (such as the 9210 Communicator made by Nokia). The provider is a hardware add-on that can be inserted into the recipient. Exemplary add-ons include Palm Bluetooth network cards, digital cameras, global positioning systems and motion-aware devices.

In the case of PDAs using the Palm OS, new devices such as the m500 series include a hardware expansion slot compatible with both the MMC (MultiMedia Card), SD (Secure Digital) and SDIO (Secure Digital Input/Output) communication protocols described in SDIO Card Specification Version 1.0, SD Memory Card Specification Version 1.0 and MMC Specification Version 2.2, the entirety of each of which is incorporated by reference. The MMC and SDIO are hardware and software-based communication protocols which can be used to transfer raw data between two endpoints, such as between a handheld device and a hardware add-on physically attached to the handheld device. As detailed in the above-referenced protocol specifications, the MMC and SDIO protocols do not correspond exactly to the physical layer of the OSI (Open Systems Interconnection) model which is commonly used to describe networking protocols.

When the m500 series was released, the drivers in these Palm OS devices only supported the MMC protocol, not the SDIO protocol. Thus, purchasers of the SDIO-based add-ons would first need to upgrade the software on the mobile device before the add-on could work. By applying the current invention, the add-on itself would be able to provide and perform any necessary upgrade with minimal user involvement.

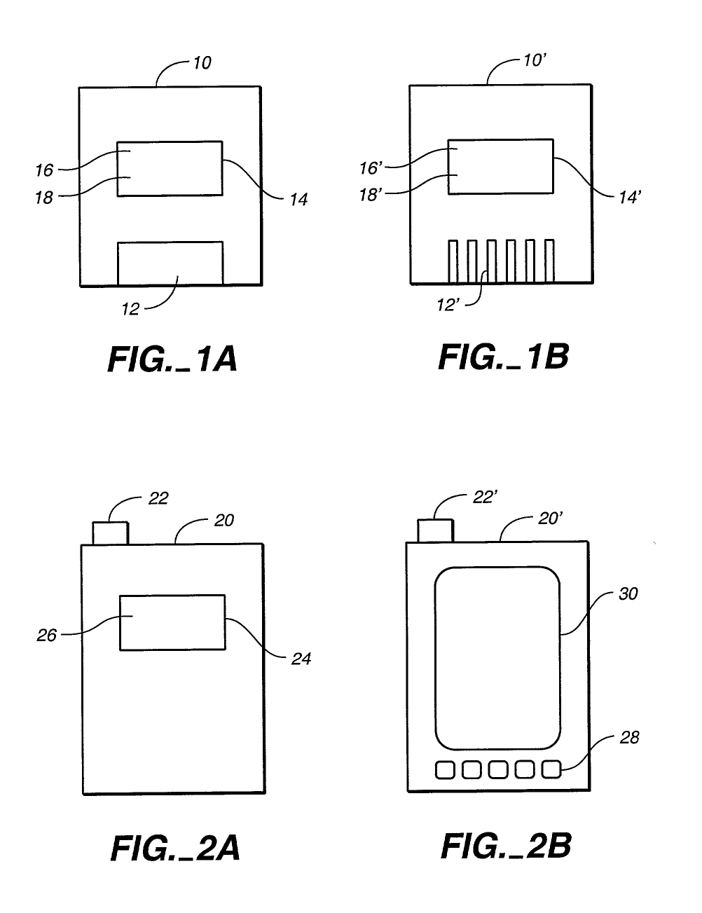

FIG. 1a shows an exemplary provider device 10 which in FIG. 1b is depicted as a hardware add-on for a PDA (but other embodiments are possible; for example, the provider could be another PDA.) The provider 10 includes an electrical connector 12 that can be coupled to a corresponding connector on the recipient device 20. The provider 10 also includes a memory 14 (preferably non-volatile) for storing the data and instructions associated with an existing software communication protocol 16 as well as a new or different protocol 18. The new software communication protocol 18 can be entirely different from the existing protocol 16 or it may share some of the same functionality as the existing protocol 16.

FIG. 2a shows an exemplary recipient device 20 which in FIG. 2b is depicted as a microprocessor-based handheld electronic device such as a PDA (shown), cellular phone, or digital camera. Alternately, the recipient could be any device with limited input capabilities (eg. limited network access or limited user-configurability). The recipient device contains a non-volatile storage 24 for storing an existing communication protocol 26 that corresponds to the protocol 16 stored in the provider. Any conventional non-volatile storage can be used, for example, a programmable memory chip or hard-wired circuitry.

For ordinary operation, the recipient device is generally mobile and need not be physically connected to a stationary computer system. The recipient device 20 includes an expansion slot 22 into which the provider 10 can be physically inserted. Other mechanisms to physically or remotely connect the two devices can also be used. However, in general, the recipient's expansion slot 22 and the provider's electrical connector 12 are formed to be physical mates such that when the two are mated, the recipient and provider become a single inertial platform. In one embodiment, the recipient and provider are physically attached together with no additional infrastructure or devices separating the two devices.

FIG. 2b shows a PDA device in which the invention can be implemented. PDAs differ from other computer designs in that a PDA typically does not contain a keyboard. Instead, the PDA's ability to receive user input is limited to a few buttons 28 and an LCD screen 30 which can respond to a stylus. These limitations make the PDA a particularly suitable platform on which to implement the invention because the invention allows for new software to be installed on the PDA with minimal user input.

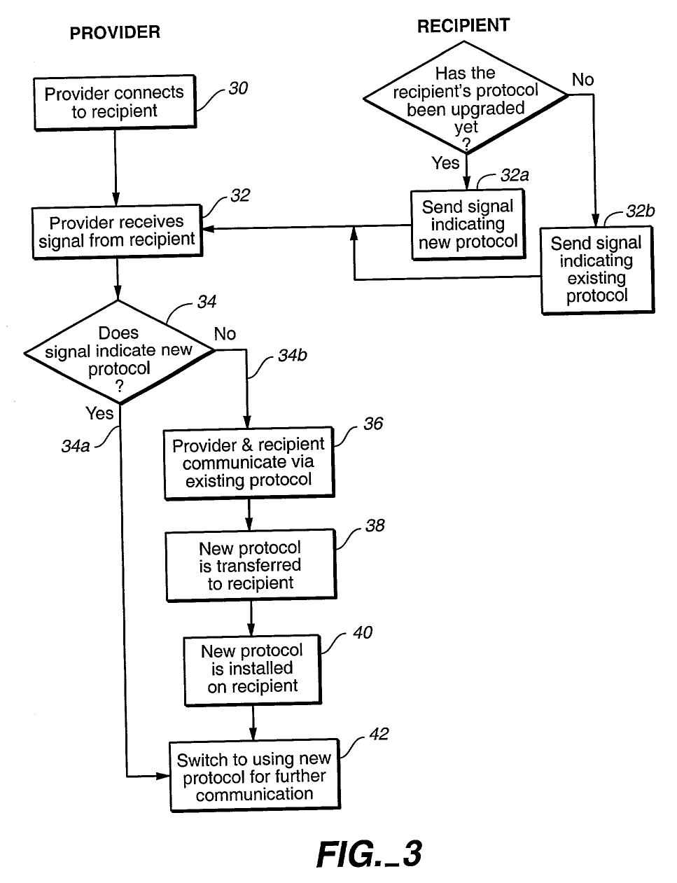

FIG. 3 shows the information flow between the recipient 10 and the provider 20 which here will be exemplified as a PDA (recipient) installed with an MMC slot driver and an expansion card (provider) capable of supporting both MMC and SDIO protocols. The information flow depicted in FIG. 3 is a method of transferring raw data between two hardware devices physically coupled together.

The method begins with the card being physically inserted into the expansion slot of the PDA (step30). After insertion, the card receives a signal from the PDA (step 32). The signal can be an initialization command or reset command to the card. The SDIO protocol dictates that if both SDIO and MMC are already installed on the PDA, then the PDA will first signal using SDIO (step 32a). Otherwise, the PDA would instead signal using MMC (step 32b).

In response, the card sends a signal back to the PDA. The card can determine the type of protocol to respond with by determining which protocol was used to send the initialization signal. For example, if the signal indicates SDIO (step 34a), then the card knows to respond with SDIO; on the other hand, if the signal indicates MMC (step 34b), then the card knows to respond with MMC. Indirectly, the card can determine that SDIO has not been installed. The SDIO protocol dictates that if both SDIO and MMC are already installed on the PDA, then the PDA will first signal using SDIO. Therefore, if the first signal uses MMC, then card can determine indirectly that SDIO has not been installed.

Based on its determination of which protocol currently exists on the PDA, the card selects the identified protocol from the plurality of communication protocols stored within its memory and successfully initializes using the identified protocol (step 36). Once communication has been established between the two devices, the PDA can search the card's file system for a recognizable executable file (for example, Palm systems use a Palm OS executable file called start.prc file). Upon locating the file, the PDA copies the file into the PDA's own file system and then executes the instructions are contained in the file. The instructions can include instructions for checking to see if SDIO driver is installed and if not, then downloading the driver file from the card (step 38) and installing the new driver (step 40). The new driver overrides the existing driver and the PDA and the card can then switch to using the new SDIO protocol for further communication (step 42).

A number of embodiments of the invention have been described. Nevertheless, it will be understood that various modifications may be made without departing from the spirit and scope of the invention. For example, although the invention has been described in connection with PDAs and add-ons for PDAs, the invention could be used in other handheld devices such as cell phones, digital or video cameras, many of which contain expansion slots capable of accepting removable storage mediums such SD/SDIO/MMC, Compact Flash or Smart Media cards. The present invention can be used in a similar fashion as described to upgrade the communication protocol of the cell phone or digital camera. Accordingly, other embodiments are within the scope of the following claims.

What is claimed is:

1. A method for delivering a communication protocol to an electronic device, comprising:
physically attaching a first electronic device having a first communication protocol to a second device having a plurality of communication protocols, the plurality of communication protocols including the first communication protocol and a second communication protocol;
establishing communication between the first and second devices using the first communication protocol;
transferring the second communication protocol from the second device to the first device;
installing the second communication protocol on the first device; and
switching to the second communication protocol for further communication.

2. The method of claim 1 wherein the first and second communication protocol are software communication protocols.

3. The method of claim 1 wherein the first and second electronic devices are handheld devices.

4. The method of claim 1 wherein the established communication is point-to-point communication.

5. A method for exchanging data between electronic devices, comprising:
physically attaching a first electronic device having a first communication protocol to a second device having a plurality of communication protocols, the plurality of communication protocols including the first communication protocol and a second communication protocol;
determining that the second communication protocol is not installed on the second device;
based on this determination, selecting the first communication protocol from the plurality of communication protocols; and
establishing communication between the first and second devices using the first communication protocol.

6. The method of claim 5 further comprising:
transferring the second communication protocol from the second device to the first device;
installing the second communication protocol on the first device; and
switching to the second communication protocol for further communication.

7. An apparatus for delivering data to a handheld electronic device, the apparatus comprising:
non-volatile storage for storing a plurality of communication protocols including a first communication protocol and a second communication protocol; and
a processor configured to:
establish communication with the handheld device using the first communication protocol;
transfer the second communication protocol to the handheld device;
install the second communication protocol on the handheld device; and
switch to the second communication protocol for further communication with the handheld device.

8. The apparatus of claim 7 further comprising an electrical connector physically coupling the apparatus to the handheld device.

9. The apparatus of claim 7 wherein the first and second communication protocol are software communication protocols.

10. The apparatus of claim 7 wherein the established communication is point-to-point communication.
